(19) United States
(12) Patent Application Publication
(10) Pub. No.: US 2017/0246073 A1
(43) Pub. Date: Aug. 31, 2017

(54) PIEZOELECTRIC COMPRESSION STOCKING

(71) Applicant: Dajustco IP Holdings Inc., Coquitlam (CA)

(72) Inventor: Peter Francis Van-De-Velde, Coquitlam (CA)

(21) Appl. No.: 15/511,865

(22) PCT Filed: May 7, 2015
(86) PCT No.: PCT/CA2015/000318

§ 371 Date: Mar. 16, 2017

Related U.S. Application Data
(60) Provisional application No. 62/052,270, filed on Sep. 18, 2014.

(51) Int. Cl. A61H 7/00

(52) U.S. Cl. CPC A61H 7/001; A61H 2209/00; A61H 2205/108; A61H 2205/106

(57) ABSTRACT

The present disclosure provides a compression stocking that comprises a tubular fabric body and a piezoelectric material that is incorporated into the tubular fabric body. The piezoelectric material changes shape in response to actuation energy to generate a compressive force. When the compression stocking is placed on a user's leg, the compressive force may compress blood vessels in the user's leg to assist with the return of venous blood.

### RELATED APPLICATIONS

This disclosure claims priority to U.S. Provisional Patent Application No. 62/052,270 entitled “PIEZOELECTRIC COMPRESSION STOCKING” filed Sep. 18, 2014, the entire disclosure of which is incorporated herein by reference.

### FIELD

The present disclosure relates to a device and method for applying a compressive force to a leg or other limb, thereby stimulating blood flow in the leg or other limb for treating or preventing a variety of blood circulation disorders. In particular, a compression stocking with an actuateable piezoelectric material is further disclosed below.

### BACKGROUND

There are a variety of venous disorders associated with poor blood circulation, and in particular poor blood circulation through the legs. Some examples of these disorders include, but are not limited to: edema, phlebitis and thrombosis. Other venous disorders, such as varicose veins, may occur when the venous valves in the legs weaken and allow blood to flow away from the heart. This causes venous blood to reflux and pool within the leg. Varicose veins may increase the risk of venous thrombosis. People who are confined to a still position for extended periods of time may also be at greater risk of developing poor venous blood circulation and the problems associated therewith. For example, patients who undergo surgery and are unable to walk for a period of time after surgery are at particular risk of developing blood clots or other emboli in the legs, due to the lack of movement of the leg muscles for extended periods of time. Further, people who travel on long airplane flights or other modes of transportation where movement is restricted for several hours, may also be at greater risk to develop venous blood clots in their legs.

A common method of treating or preventing the various venous disorders and other medical conditions described above is for the person to wear compression stockings. Compression stockings are stockings designed to apply a compressive force to the veins, arteries and muscles of the legs on which they are worn. The compression of the surface blood vessels of the leg on which the compression stocking is worn serves to narrow the blood vessels, thereby increasing arterial blood pressure. Increased arterial blood pressure will increase the venous return to the heart and; therefore, less blood will pool in the lower extremities. The compression force may also improve venous compression, which may assist in advancing blood through the veins of the user's leg. The compressive force applied by the stocking is typically generated by strong elastics or other rubber materials that are woven throughout the length of the compression stocking. Compression stockings may be designed to apply even pressure throughout the length of the stocking. Additional, gradient compression stockings are designed to apply a greater amount of pressure around the ankle area, with a gradually decreasing amount of pressure through the length of the stocking towards the upper thigh. In some cases, compression stockings are prescribed as part of the treatment of an existing venous disorder, while in other cases, compression stockings may be prescribed as a measure to help prevent venous disorders, such as when a patient has gone through surgery and will be unable to move about freely for a period of time after surgery, or for a traveller embarking on a long trip and who is at particular risk of developing blood clots during long periods of inactivity. Compression stockings may also be used by athletes to improve performance or assist in recovery, by stabilizing the muscles and improving both blood circulation and lactic acid removal from the leg muscles.

Existing compression stockings or socks (collectively referred to herein as “stockings”) known in the prior art apply a constant amount of force to the leg, in part to make up for the lack of muscle action in the leg that assists with stimulating blood flow throughout the leg.

A further issue with the compression stockings known in the prior art is that the amount of pressure that needs to be applied for optimal treatment may vary at times for a particular patient. While different compressive forces may be achieved by purchasing different compression stockings that are designed to apply different amounts of pressure, one cannot adjust the compressive force being applied by a particular compression stocking as required to suit the needs of the patient. If a patient requires a different compressive force to be applied, a different compression stocking must be acquired that will apply the appropriate compressive force. Another problem is that the existing compression stockings are delicate and susceptible to damage due to the fibres of the stocking catching or snagging on a person's nails, jewellery or other sharp objects, which may necessitate the person to wear gloves when putting on or removing the stockings in order to minimize the potential damage. This makes it generally inconvenient for the person to put on or remove the stockings in order to either apply or remove the compressive force from the legs.

### SUMMARY

A stocking is described below that comprises a first end, a second end and a piezoelectric material. The piezoelectric material extends at least partially between the first and second ends and the piezoelectric material is incorporated into the fabric of the stocking. The stocking further includes a controller that operatively connects the piezoelectric material to a source of actuation energy. In response to actuation energy, which is regulated by controller, the piezoelectric material can deform and move between a first length and a second length. The piezoelectric material acts as piezoelectric actuator.

In one example embodiment, the piezoelectric material is a fibre that is woven into the fabric of the stocking in a helical fashion between the first and second ends. Optionally, the piezoelectric material is woven into the fabric of the stocking with a first weave density and a second weave density between the first and second ends. The first weave density may be positioned proximal to the first end and the second weave density may be positioned proximal to the second end. The first weave density may be greater than, smaller than or the same as the second weave density.

A method of applying a compressive force to a surface is also described below. The method comprises a step of applying a flexible fabric about an appendage of a user that will receive the compressive force. The fabric comprises a piezoelectric material. Actuation energy is applied to the piezoelectric material, which causes the piezoelectric material to change shape, for example contract and shorten. Changing the shape of the piezoelectric material generates an inwardly directly the compressive force. Optionally, the electric current may be applied in pulses. In another option, the shape of the piezoelectric material shortens first at one end of the flexible fabric, at both ends of the flexible fabric, between the two ends of the flexible fabric or any combination thereof.

The stocking described below is capable of applying a modifiable compressive force inwardly to a user's leg, whereby the compression effect of the stocking may be turned on or off, or otherwise adjusted, as desired without necessitating removal of the stocking. Without being bound by theory, applying a modulated compressive force to the leg may facilitate circulation of venous blood through the leg. A modulated compressive force may simulate the effect of contracting muscles by increasing and decreasing the compressive force while the stocking is worn.

### BRIEF DESCRIPTION OF THE DRAWINGS

Various examples of the apparatus are described in detail below, with reference to the accompanying drawings. The drawings may not be to scale and some features or elements of the depicted examples may purposely be embellished for clarity. Similar reference numbers within the drawings refer to similar or identical elements. The drawings are provided only as examples and, therefore, the drawings should be considered illustrative of the present invention and its various aspects, embodiments and options. The drawings should not be considered limiting or restrictive as to the scope of the invention.

FIG. 1 is a side elevation view of one embodiment of the compression stocking.

FIG. 2 is a side elevation view of another example embodiment of a compression stocking.

FIG. 3 is a front elevation view of an example embodiment of a controller for use with the compression stocking of FIG. 1 or FIG. 2.

FIG. 4 is a front elevation view of an example embodiment of a remote controller for use with the compression stocking of FIG. 1 or FIG. 2.

### DETAILED DESCRIPTION

The present invention provides a compression stocking that is designed to provide a modulated or pulsating compressive force throughout the length of a person's leg when the stocking is worn on the leg. Optionally, the greatest amplitude of the compressive force is applied by the compression stocking around the ankle, with the compression gradually decreasing upwardly along the length of the leg whereby the least amount of compression applied by the compression stocking occurs at the upper thigh of the leg. In other embodiments of the present invention, the length of the compression stocking may vary such that the length extends from the ankle to the knee or from the ankle to the lower section of the thigh, depending on the particular needs of the person wearing the compression stocking. The compression stocking may have a foot-covering section, where the user's foot resides while the stocking is worn, such that at least part of the user's foot is covered by the compression stocking; or the compression stocking may end at the ankle so as to not cover the foot of the person wearing the stocking.

The modulation or pulsating motion of the stocking according to one aspect of the present invention is provided by means of a piezoelectric material that changes shape in response to electric current. As will be appreciated by those skilled in the art, various different types of known, and not yet known, piezoelectric materials are suitable for use in the present invention, due to the dynamic movement that is required to generate a compressive force the piezoelectric material is preferably flexible and deformable. In one embodiment, the piezoelectric material may comprise a polymer that is incorporated into the flexible material of the compression stocking as a polymer sheet or a fibre. The term “fibre” used herein to refer to any filamentous structure, such as a multi-component yarn, string, cord (whether twisted or braided or otherwise entwined), or other elongate, flexible and possible stretchable members. The “fibre” may include multiple individual piezoelectric actuators that are aligned in parallel with each other, positioned end to end from each other, or not. The fibres of piezoelectric material 10 may be embedded in a polymer to form sheet like structures of the piezoelectric material 10, or not. The piezoelectric material 10 deforms, for example it changes shape by expanding and/or contracting when it is exposed to an actuation energy. Without intending to be limiting, the actuation energy may be a voltage or electric current.

The piezoelectric material is incorporated into the fabric of the compression stocking, so as to form part of the compression stocking fabric. In the embodiments where the piezoelectric material is a sheet, the sheets of piezoelectric material may form one or more layers that are incorporated into the compression stocking fabric, for example by adhering one or more sheets of piezoelectric material to one or both sides of the fabric of the compression stocking. In the embodiment where the piezoelectric material is in the form of a fibre, the piezoelectric material may be incorporated by being woven into the fabric of the compression stocking. The application of an actuation energy to the piezoelectric material causes the fibre to deform, which is also referred to as changing shape, for example by lengthening by expansion or shortening by contraction. The term “contraction” is used herein to refer to a decrease in overall length of the piezoelectric material due to a change in shape, discontinuing the application of the actuation energy may cause the piezoelectric material to relax. In some embodiment, the piezoelectric material may also have some elastic properties so that it can return to its original shape and length when the application of the actuation energy stops. Applying actuation energy to the piezoelectric material may cause a shape change that result in a greater or smaller overall length of the fibre.

In a further optional embodiment, the applied actuation energy can be modulated to cause the piezoelectric material to decrease in length, increase in length and return to its shape and length prior to the application of the actuation energy. The actuation energy may be a voltage signal or an electric current. The electric current may be analogue modulated by changing one or more of the electric current's amplitude, frequency or phase. Various other means, known to those skilled in the art, by which the actuation energy can be modulated to cause shortening, extension or relaxation of the fibre, are also within the scope of the present invention.

In some embodiments of the present invention, the compression stocking may be entirely manufactured of the piezoelectric material and a flexible fabric or only portions of the compression stocking may include the piezoelectric material. For example, if only portions of the compression stocking include the piezoelectric material, then compressive forces may be generated at different sections of the compression stocking. For example, when an electric current is applied to a piezoelectric fibre, the fibre may contract in length, resulting in a compression of the overall structure of the compression stocking. When the electric current ceases to flow through the electrically conductive fibre, the fibre may expand, lengthen, and relax so as to return to substantially its length and shape prior to the application of the electric field, which is may be referred to as the original length and shape. When the fibre returns to its original length and shape, the compressive force on the user's leg is reduced. One portion of the compressive stocking may have a greater weave density of piezoelectric fibre materials, which may produce a greater compressive force as compared to portions of the compression stocking with a lesser weave density of piezoelectric fibre materials.

Another embodiment of the present invention may further include an electrically conductive fibre that acts as a conductor to distribute the electric current from the current source throughout different portions of the compression stocking that include the piezoelectric material. Without intending to be limiting, one example of a suitable electrically conductive fibre is a silver-plated nylon yarn such as for example the commercially available Shieldex® Conductive Twisted Silver Plated Nylon 66 Yarn, marketed by VTT/Shieldex Trading USA, of Palmyra, N.Y., USA. This example fibre consists of three strands of nylon 6, 6 that are plated with silver and twisted to form a yarn. It is well understood by a person ordinarily skilled in the art that other electrically conductive fibres may exhibit expansion and/or contraction properties upon the application or removal of an electric current and these other electrically conductive fibres may be utilized in the device described herein. For Example, other synthetic or natural fibres that are electrically conductive and which exhibit expansion and contraction properties upon the application or removal of an electrical current may be used.

The actuation energy for the electrically conductive fibres may comprise voltage or electric current that is supplied by a power source. The power source may be portable, for example a battery provides voltage that is modulated by a suitable controller circuit or switching device. For example, which is not intending to be limiting, the battery may be a standard watch battery. In an alternative example, the power source may be an electrical cord, than may include a step-down transformer, such as a USB mobile device charging cord. Optionally, the controller is able to control at least one of the frequency, amplitude, or phase of the actuation energy that is being applied to the piezoelectric material. For example, a control chip may be programmed to turn the actuation energy supplied by the power source on and off at pre-defined intervals. The compression stocking may be worn with a constant actuation energy being applied to the compression stocking while in use. In an alternate embodiment, the actuation energy may be applied to and then removed from the conductive fibre in a pulsating pattern, whereby the compression stocking for example continually expands and contracts in a pulsating motion, thereby applying a pulsating compressive force to the leg to stimulate the flow of blood through the leg. The actuation energy may also be turned on and off via a control accessible to the wearer of the stocking, such that the compressive effect of the stocking may be turned on or off as desired without having to remove the compression stockings from the user's legs.

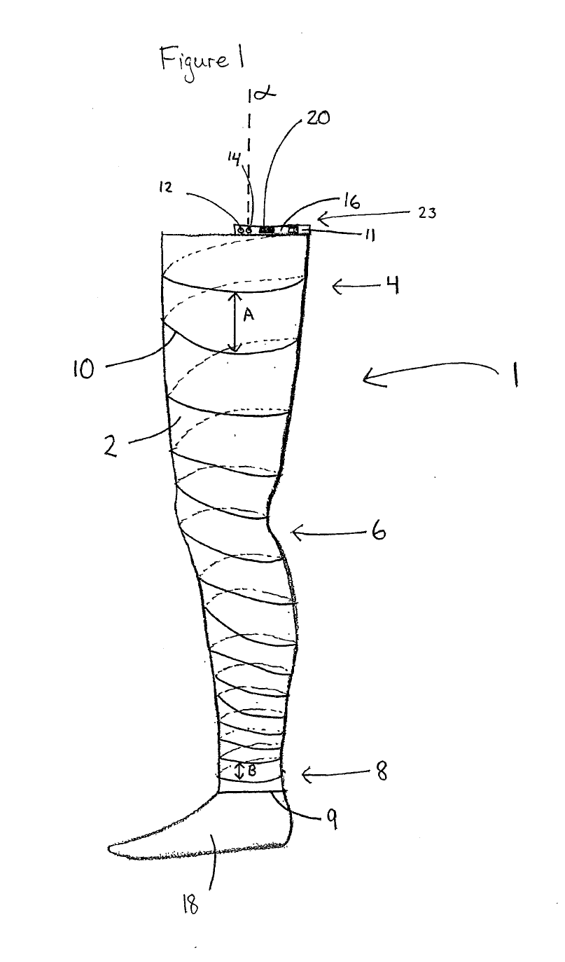

FIG. 1 depicts one example embodiment of a compression stocking 2 that is worn over a user's leg 1 and that has an upper thigh section 4, a knee section 6 and an ankle section 8. The ankle section 8 may also be referred to as a first end of the stocking 2 and the upper thigh section 4 may also be referred to as a second end of the stocking or vice versa. A lower opening 9 is located near the ankle section 8, such that the compression stocking 2 does not cover the foot 18 of the person. Optionally, the stocking 2 may also include a foot section that covers the user's foot. The foot section may be closed or not. As described above, a piezoelectric material 10 may be incorporated into the material of the stocking 2. For example, in one embodiment the stocking 2 material may be an elastic material and the piezoelectric material 10 may be a fibre that is woven in a helical fashion throughout the entire length of the compression stocking 2. The helical loops of the piezoelectric material 10 are oriented to wrap around a longitudinal axis of the stocking 2 (line a in FIG. 1, which also depicts a longitudinal axis of a user's leg 1 when straight). Optionally, different sections of the compression stocking 2 may have different spacing of piezoelectric material 10. For example, at the upper thigh section 4 of the compression stocking 2, adjacent loops of the piezoelectric material 10 may be spaced apart by distance A, while adjacent loops of the piezoelectric material 10 are spaced apart from each other at a distance B near the ankle section 8 of the compression stocking 2. The distance A may be greater than the distance B, or not. In this embodiment, the piezoelectric material 10 may lengthen in response to the actuation energy. The lengthening of the piezoelectric material generates the compressive force.

In an alternative embodiment, multiple fibres of the piezoelectric material 10 may be incorporated into the fabric of the stocking 2 as discrete open or closed loops rather than a single continuous fibre that extends between the first and second ends, as described in the embodiment above. The discrete open or closed loops may wrap around the longitudinal axis of the stocking 2. The discrete loops may be equally spaced apart, or not. In this embodiment, the piezoelectric material may shorten, or contract, in response to the actuation energy. The shortening of the piezoelectric material may generate the compressive force.

Optionally, the distance between adjacent loops of the piezoelectric material 10 can increase towards the upper thigh section 4 of the compression stocking 2, as compared to towards the ankle section 8. Optionally, this differential spacing of the piezoelectric material 10 can be used in the helically woven embodiment and the discrete loops embodiment described above. The differential spacing of the piezoelectric material 10 through the length of the compression stocking 2 provides a helical density that progressively increases from the upper thigh section 4 towards the ankle section 8 of the compression stocking 2. When the actuation energy is applied to the piezoelectric material 10, the piezoelectric material 10 will deform and change in shape and/or length. The deformed piezoelectric material 10 will generate a compressive force, the amplitude of which may be smaller at the upper thigh section 4 and larger at the ankle section 8. The stocking 2 may generate a gradual progression of the compressive force amplitude from the lowest compression at the upper thigh section 4 through to the greatest compression at the ankle section 8. Alternatively, the spacing between adjacent loops of piezoelectric material 10 may be substantially same, which when an electric current is applied to the piezoelectric material 10 may generate substantially the same compressive force along the length of the compression stocking 2.

Although a single fibre of piezoelectric material 10 is illustrated in FIG. 1, multiple fibres of the piezoelectric material 10 may be incorporated into the material of the compression stocking 2 to achieve the desired level of compression in the ankle section 8, knee section 6 and upper thigh section 4 of the compression stocking 2. In another embodiment, a helical arrangement is not used. Rather, the one or more fibres of piezoelectric material 10 are woven into the fabric of the compression stocking 2 in other arrangements or weaving patterns.

As illustrated in FIG. 1, which is not intended to be limiting, the compression stocking 2 may also include a controller 11. In one embodiment, the controller 11 comprises an on switch 12, an off switch 14 (or a single power switch), various control switches 23, a power source housing 16 and a removable door 20 that may be hingedly connected to the power source housing 16. The removable door 20 may be removed for the insertion of a power source, such as for example a battery (not shown) or to connect an electrical cable between a power source housing 16 and the controller 11. The electrically conductive fibre 10 is electrically connected to the controller 11 and the power source.

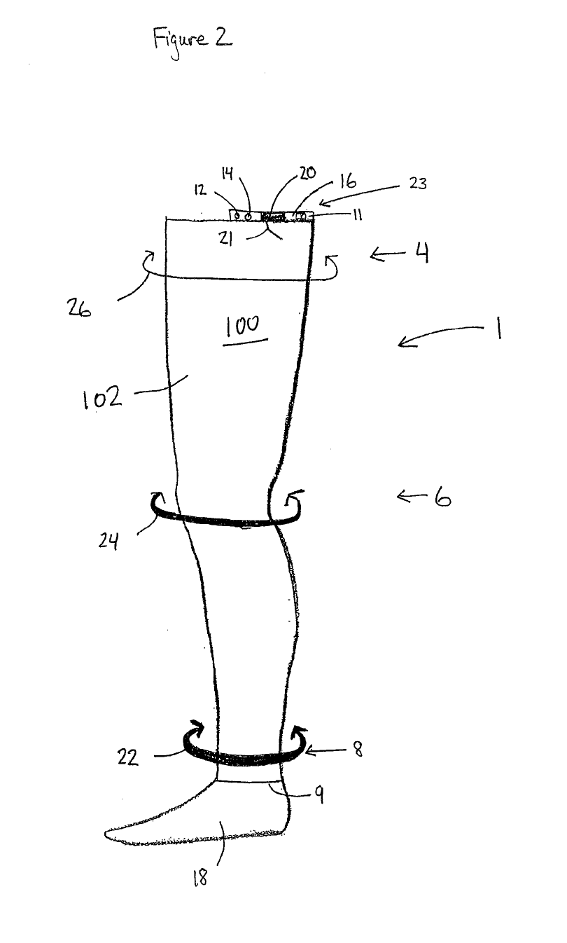

In an alternative embodiment of the present invention, as illustrated in FIG. 2, substantially the entire fabric of a compression stocking 102 is made up of the piezoelectric material 10. Optionally, the compression stocking 102 may comprise multiple fibres of piezoelectric material 10 that are woven into a piezoelectric fabric 100. A lead wire 21 may provide an electrical connection between the piezoelectric fabric 100 of the compression stocking 102, and on, off switches 12, 14 at a controller 11. The weave density of the piezoelectric material 10 within the piezoelectric fabric 100 may be greatest near the ankle section 8 of the compression stocking 2 and becomes progressively less dense towards the upper thigh section 4. FIG. 2 includes three arrows 22, 24, 26 whose relative thickness indicates the amplitude of the compressive force generated in a given section of the compression stocking 102. For example, the thicker arrow 22 indicates a compressive force amplitude that is greater than arrow 24, which in turn is thicker than arrow 26, such that when the actuation energy is applied to the piezoelectric fabric 100 of the compression stocking 2, the compressive force 22 amplitude may be greatest at the ankle section 8, while the compressive force 24 experienced near the knee section 6 is somewhat less, and the compressive force 26 experienced at or near the upper thigh region 4 is lowest. This differential amplitude of the compressive force generated within different sections of the stocking 2 may be related to the different weave densities within each section of the compression stocking 102. Alternatively, the stocking 102 may comprise multiple sheets of piezoelectric material 10 that are incorporated into the fabric of the stocking 102 for substantially the entire length of the stocking 102 between the first and second ends.

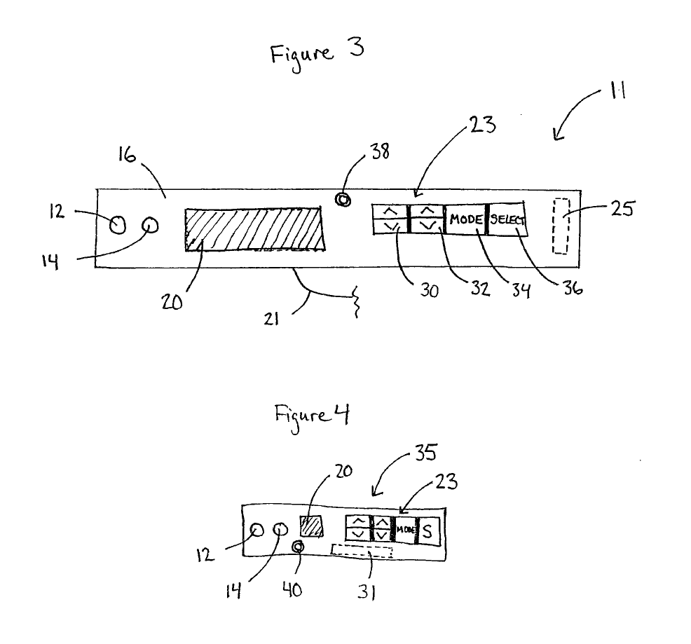

FIG. 3 depicts an example controller 11 that further includes a wireless receiver and transmitter 25. The wireless receiver and transmitter 25 may be integrated within the controller 11 and it may be in wireless communication with another control device, such as for example a remote controller 35, as illustrated in FIG. 4. Optionally, the remote controller 35 may be device manufactured solely for communicating with the controller 11 or it may be a mobile phone, a personal computer or a tablet computer loaded with application software capable of receiving data from and sending control signals to the controller 11. This embodiment enables the user or a nurse, doctor or other caregiver, to control and adjust the compression stocking 2 without having to physically access the controller 11. In other embodiments of the invention, the remote controller 35 may communicate with the controller 11, for example by sending and receiving signals and data to and from the controller 11 by means of an electrical wire (not shown). The electrical wire connects the remote controller 35 at a first end of the electrical wire via a port 40 and a second end of the electrical wire to the controller 11 via a port 38. It will be well understood by a person ordinarily skilled in the art that other methods of establishing communication between the controller 11 and the remote controller 35 may be suitable and will be within the scope of the present invention.

Optionally, the controller 11 may have one or more control switches 23 that are used to modify the functionality of the compression stockings 2, 102. For example, a pressure control switch 30 may be utilized to increase or decrease the amplitude of the compressive force that is generated by the compression stocking 2. A frequency control switch 32 may be utilized to increase or decrease the frequency of compressive force pulses that are delivered to the leg 1 of the user. For example, the frequency of compression force pulses may be between 1 and about 20 strokes per minute. Optionally, the pulse frequency may be higher.

Furthermore, a mode switch 34 and a select switch 36 may be provided to enable selection of various modes of operation for the compression stockings 2, 102 for example: in one example mode of operation the compressive force pulses may be programmed to travel progressively up the leg 1 of the person wearing the compression stockings 2, 102 whereby the compressive force pulses are first applied to the ankle section 8 and then travel progressively upwards towards and through the knee section 6 and then travel progressively upwards towards and through the upper thigh section 4. In another example mode of operation, the compressive force pulses travel progressively down the leg 1 of the person wearing the compression stocking 2, whereby the compressive force pulses are first applied to the upper thigh section 4 and then the compressive force pulses travel downwards towards and through the knee section 6. Then the compressive force pulses travel progressively towards and through the ankle section 8. In another example mode of operation, the compressive force pulses are first applied at any position between the top and bottom of the compression stocking 2. In this example mode of operation, the compressive force pulses may travel upwards, downwards, or both, from the site of where the compressive force is first applied. In another example mode of operation, the pulses of compressive forces are applied intermittently, which may be random or not, throughout the leg 1. In another example mode of operation, the pulses of compressive forces are applied in a pre-determined pattern that may or may not focus on various sections 4, 6 and 8 of the leg 1. In another example mode of operation, the compressive forces are applied in one of the pre-determined patterns as described above, and then switched to another of the pre-determined patterns described above after a pre-determined interval or when changed by the user. Optionally, the pulses of compressive forces may be applied according to one or more predetermined patterns and then switched to be applied intermittently, and vice versa. In another example mode of operation, the pressure, frequency and pulsating pattern of the compression stockings 2, 102 are programmed to operate on the left leg independently of the right leg; and a mode of operation whereby the compression stocking 2 is turned on or off, and/or the frequency and/or the amplitude of the compressive force applied to the leg 1 by the compression stocking 2 is either increased or decreased after a pre-determined period of time.

The modes of operation described above are provided only to illustrate the many possibilities of what may be achieved with respect to the control and patterning of the compressive forces to be applied to the leg 1 of a user of the compression stockings 2, 102. However, it will be well understood by a person ordinarily skilled in the art that various different modes of operation may be achieved by the controller 11 of the compression stockings 2, 102 disclosed herein and that the compression stockings 2, 102 are not in any way limited to the modes of operation described above.

While the above disclosure describes certain examples of the present invention, various modifications to the described embodiments will also be apparent to those skilled in the art. The scope of the claims should not be limited by the examples provided above; rather, the scope of the claims should be given the broadest interpretation that is consistent with the disclosure as a whole.

What is claimed is:

1. A compression stocking comprising:
a tubular fabric body with a first end and an open second end for positioning about a user's leg;
a piezoelectric material that is incorporated into the tubular fabric body, the piezoelectric material is deformable in response to an actuation energy for generating a compressive force that is applicable to the user's leg;
a controller that is electrically connectible to a source of actuation energy and to the piezoelectric material, the controller for providing and regulating the actuation energy to the piezoelectric material.

2. The compression stocking of claim 1, wherein the tubular fabric body further comprises an elastic material.

3. The compression stocking of claim 1, wherein the first end is closed.

4. The compression stocking of claim 1, wherein the piezoelectric material is a fibre that is incorporated into the tubular fabric body as one or more loops about a longitudinal axis of the tubular body.

5. The compression stocking of claim 5, wherein adjacent loops of the fibre are spaced apart from each other at substantially the same distance.

6. The compression stocking of claim 4, wherein proximal to the first end the adjacent loops of the fibre are spaced apart from each other by a distance A and proximal to the second end the adjacent loops of the fibre are spaced apart from each other by a distance B.

7. The compression stocking of claim 7, wherein distance A is greater than distance B.

8. The compression stocking of claim 1, further comprising a conductor that electrically connects the controller and the piezoelectric material.

9. The compression stocking of claim 1, wherein the piezoelectric material is flexible.

10. The compression stocking of claim 1, wherein the piezoelectric material is a polymer.

11. The compression stocking of claim 1, wherein the controller regulates the electric current so that the piezoelectric material generates a pulsatile compressive force.

12. The compression stocking of claim 1, wherein the controller regulates the electric current to modulate at least one of the compressive force's amplitude and frequency.

13. The compression stocking of claim 1, further comprising a remote device for sending commands to the controller for regulating the electric current and modulating at least one of the compressive force's amplitude and frequency.

14. A method of applying a compressive force to a user's leg, the method comprising steps of:
a. providing a piezoelectric material about a longitudinal axis of the user's leg; and
b. applying an actuation energy to the piezoelectric material for generating the compressive force.

15. The method of claim 14, further comprising a step of modulating the actuation energy for applying the actuation energy at one end of the user's leg.

16. The method of claim 14, further comprising a step of modulating the actuation energy for increasing or decreasing an amplitude of the compressive force.

17. The method of claim 14, further comprising a step of modulating the actuation energy for applying the actuation energy in a pulsatile fashion.

18. The method of claim 17, further comprising a step of changing a frequency of the pulsatile actuation energy.

19. The method of claim 14, further comprising a step of providing a greater density of piezoelectric material at a first end of a user's leg than a second end of the user's leg so that an amplitude of the compressive force is greater at the first end of the user's leg than the second end.

20. The method of claim 19, wherein the first end is proximal to a user's ankle and the second end is proximal to a user's thigh.
